(19) United States
(12) Patent Application Publication
(10) Pub. No.: US 2002/0031586 A1
(43) Pub. Date: Mar. 14, 2002

(54) Collapsible mould for frozen food blocks with bulging-free surfaces

(76) Inventor: Lindsay George Wyborn, Hamilton (NZ)

Correspondence Address: STETINA BRUNDA GARRED & BRUCKER, 75 ENTERPRISE, SUITE 250, ALISO VIEJO, CA, 92656, US

(21) Appl. No.: 09/908,365

(22) Filed: Jul. 18, 2001

Related U.S. Application Data
(63) Continuation of application No. 09/253,642, filed on Feb. 19, 1999, now abandoned.

(30) Foreign Application Priority Data
Aug. 22, 1997 (NZ) PCT/NZ97/00103
Aug. 22, 1996 (NZ) 299221

(51) Int. Cl. A22C 7/00

(52) U.S. Cl. 426/513; 426/524; 249/102; 249/82; 249/160; 249/163

(57) ABSTRACT

A collapsible mould for preforming produce in a frozen state includes top, bottom and side surfaces and biasing means for yielding against expansive pressure of the produce encountered during freezing, which surfaces are self-supporting against the forces of expansion during the freezing process.

### TECHNICAL FIELD

This invention relates to a mould.

Reference throughout the specification shall be made to the use of the present invention as a mould for freezing meat. It should be appreciated however that the principles of the present invention can apply to other products, particularly products which expand after being packaged.

### BACKGROUND ART

To meet consumer demand, vast amounts of food are preserved frozen. This means that considerable resources are required to provide cold storage and transportation. For example, the freight bill for New Zealand's meat exports alone amounts to several hundred million dollars per annum. Current freight payment structures and competition mean that if there was any way in which stowage densities could be raised, considerable savings could result.

Unfortunately, current practices of freezing meat do not result in optimum stowage densities. For example, cartons of frozen meat exported from New Zealand do not always have flat surfaces and are prone to pronounced bulging.

The applicant has recognised that the volume taken up from bulging cartons and non-optimally sized cartons is waste space that is still paid for in transport and storage of the meat.

It would be ideal if carton bulging could be eliminated and frozen meat could be in a configuration that enables the meat to be optimally stacked with minimum air space.

One problem with meat as it freezes is that it expands. This means that even if the unfrozen meat were in a configuration that allowed for optimal stowage capability, the frozen meat may have expanded to a less than optimal configuration.

If meat is entirely constrained during the freezing process, very high pressures can be generated. Current thinking therefore is that to constrain the meat as it freezes would require heavy moulds to withstand the pressures generated by the expanding meat.

A way of economically shaping meat into a predefined form in its frozen state would have considerable advantages over previous systems.

An obvious advantage is the potential for increased stowage density which leads to less shipping and storage costs, and may improve the economics of unitisation whether on pallets or on slipsheets. Cartons with consistent and stackable shape make self-contained unit loads a possibility.

Uniformity of shape would allow stacks of products to be more stable thus making handling of unit loads safer, improving the practicality of slipsheets, reducing damage and enhancing product image.

Improved symmetry of stacked carcasses that are regular in shape could also make counting easier.

If carcasses are frozen into a consistent rectangular shape, the flat surfaces produced would make bandsaw cutting easier and safer and result in more uniform and rectangular shaped cuts.

If the meat was of a stackable configuration and thus self supporting, then the use of cartons may be obviated and lighter packaging may be used. As the cardboard volume of the cartons can account for approximately 5% of the total volume, then elimination of the cardboard can lead to a significant saving in both storage space and material.

Cartoned meat may be frozen in moulds, however, freezing meat in stainless steel moulds instead of cardboard cartons has a significant impact on freezing time; in theory, reducing freezing time by a third, and up to a half if there is a reduction in bulging. Furthermore, this reduced freezing time may similarly be reduced by the same proportion (i.e. by a third), if polythene liner bags are eliminated and meat is packed directly into stainless steel moulds, see Earle and Freeman “Continuous Tunnel Freezing of Boneless Meat in Cartons”, Institute International du Froid International Institute of Refrigeration, 1966, p 663.

If a system was implemented for preforming the carcasses, that system could be such that the carcasses could be bagged or wrapped after freezing, thus reducing the amount of snow.

It would also be an advantage if the means for shaping meat could also contribute to a reduction in conventional freezing times.

It is an object of the present invention to address the foregoing problems or at least to provide the public with a useful choice.

Further aspects and advantages of the present invention will become apparent from the following description which is given by way of example only.

### DISCLOSURE OF INVENTION

According to one aspect of the present invention there is provided a method of treating produce to be frozen, characterised by the steps of:

a) placing the unfrozen produce into a fully enclosed mould, and

b) freezing the produce within the mould

wherein the mould has sufficient rigidity to shape the produce to a desired form during the freezing process.

The applicant has observed that during the process of freezing, ice passes through a “plastic” phase. This phase allows the expansion of the ice to follow paths with least resistance. This means that only moderate resistance is required to divert the expansion of produce during the freezing process. Provided a mould has sufficient space within the mould to accommodate the diverted expansion, then moderate constraint from the mould on the produce can be remarkably effective. Even when mould surfaces are prone to excessive flexure, they may be shaped to project inwards so that stackability of the frozen product is not compromised.

Reference throughout the specification shall be made to the produce as being meat.

The amount of meat, moisture content, size and shape of the mould, and freezing rate are factors that can affect mould performance. For instance, the rectangular shape of meat cartons means that when meat freezes in a mould with the same geometry, the centre of the top and bottom surfaces of the mould are the weakest points most susceptible to any internal expansive pressure from the meat. In such a mould, consistent shape retention studies indicate that the peripheral surfaces of the meat that freeze solid first are the end and side walls. Therefore, with the mould wall surfaces so effectively constraining outward movement, expansive pressure is directed inwards and exposes the top and bottom surfaces (that are the most vulnerable surfaces) to the highest pressure. In such cases when a degree of top and bottom surface bulging is inevitable it can be substantially reduced by relatively moderate strengthening measures of the mould in the region of these susceptible areas. For instance, by using a different type or grade of stainless steel, patterning and/or embossing, or increasing the moment of inertia with thicker material and/or strategically placed folds/bends.

Expansion of meat surfaces can also be rendered unobtrusive by incorporating flexible diaphragms into moulds that indent the fresh product and then yield in a desired manner during freezing. For instance, having the susceptible surfaces of a mould project inwards prior to freezing can effectively absorb and mask the product's outward expansion by keeping product bulging within (or close to) the profile of the outer edges of the mould.

Bulging of just one surface of a frozen block of meat may also produce uniformly stackable frozen blocks. For instance, the mould may be shaped so that it has a concave base and the lid is allowed to yield to expansive pressure or may even be preformed to a convex shape. The concave base being substantially more rigid than the lid to ensure expansion of the meat during freezing does not have an untoward affect on the desired concave base shape. On the other hand the lid may even be shaped (ie. convex) so as to allow room for expansion of the meat into this outwardly curved area. The net result is frozen blocks of meat which are shaped so that the respective base and lid (top) portion of individual blocks can mate together to form a compact stack of blocks.

If only moderate external constraints are required, relatively lightweight and inexpensive moulds can be effective as opposed to having substantial and expensive moulds that orthodox thought would have previously considered necessary.

The moulds may be made out of a variety of materials providing the material exhibits the required combination of flexibility and rigidity, for example, plastics and laminated cardboard. In preferred embodiments, the mould material is food grade stainless steel sheetmetal, although other materials may of course be used.

In some embodiments, the mould material may be either magnetic or able to be gripped by a magnet.

There are many possible configurations of moulds which can be made in accordance with the present invention.

In one embodiment, the mould may consist of two pieces, an open box and a lid fabricated out of sheetmetal.

The box may be a single piece of sheetmetal with sides bent upwards from the base. If, as preferred, the edges of the sides of the open box are not joined to each other, then the stiffness of the sides is the sides only resistance to flexure.

The meat of course may be frozen directly in the mould, in a plastic film, cardboard, a barrier bag or any other packaging material within the mould.

To allow for possible liquid (blood) seepage from the meat in the mould suitable lip configurations may be incorporated.

To provide a lighter weight mould, the sheetmetal or other materials used may be perforated.

The lid may also be fabricated from a single piece of sheetmetal. Preferably the edges of the sides of the lid are also not joined. However, as the sides of the lid are smaller than the box, they will be stiffer than the box and thus serve to hold the top of the box in place. The lid may also reinforce the resistance of the sides to bulging.

The main advantage of having unjoined sides is that the sides of the box can flex to allow ready removal of the meat after it is frozen. Further, this feature also avoids the additional expense that welding of adjacent edges would entail.

To aid the extraction of the frozen blocks of meat, push-out panels may be provided.

It should be appreciated that the meat surface may not be always uniform as voids within the mould frozen meat result in frozen blocks having fissured outer surfaces. Although the surfaces may not be completely flat due to mould design and packing density, the moulds will still fulfil the function of producing blocks that have enough peripheral dimensions consistently defined to allow the blocks to be symmetrically and compactly stacked together.

The lid and box may have additional features which assist in holding the mould together. For example, there may be mating dimples which secure the lid in place against upward pressure from the expanding meat. There may also be provided a flange bent from the sheet metal making up the lid which provides further stiffening to the lid and allows easy lid removal.

Many different clamping methods (fixed, adjustable, or spring-loaded) may be used to hold mould components in place. Such methods will withstand expansive pressure during freezing and may also be used in the application and maintenance of pressure to the freshly-loaded product. Prior to freezing, a product may be constrained with the mould exerting little or no pressure. However, when moulds do apply pressure to compress the fresh product and reduce entrapped air, this reduces the volume and improves the surface appearance of the frozen block. Enhancing compactness in this way, will provide a critical improvement and significantly raise stowage density, when it allows for an extra block than would otherwise fit in each row or tier.

Prior to or in the course of mould securement, pressure to displace and reduce entrapped air might be temporarily applied via means such as weights, wedges, packing pieces, springs, levers, screws, cams or rams. Otherwise, pressure might be directly applied by the means of securement; for example, using a lever and/or cam.

To further aid lid removal, a mechanical device may be provided.

It may be possible that the material used for the moulds does not have sufficient stiffness if used in a substantially flat form. Thus, there may be techniques employed in the making of the moulds which provide additional stiffening or flexural rigidity. For example, shallow indentations may be pressed into the box or lid. These indentations may be patterns or shallow channels which form stiffening ribs. Naturally such modifications to the surface of the lid or box will increase the moulds surface area. In some embodiments a logo may be imprinted which in addition to providing stiffness also provides a decorative and promotional device. The indentations may cause a channel to be formed across a face or faces of the meat which may serve to accommodate a bag seal or perhaps make handling easier by improving grip.

In preferred embodiments indentations may also serve another function; for instance, when an overlap of cardboard in a carton projects inwards at a join and breaks the clean line of the internal surface of the carton, snug fitting of the frozen block within the carton is compromised. However, to compensate, a shallow indentation in the mould or an appropriately-sized packing strip may be used to form an impression in the surface of the frozen block that matches the projecting cardboard.

Cartons can easily be damaged when heavy frozen blocks are placed in light-weight cardboard cartons, especially when they are a tight fit. However, a simple way to avoid this awkward exercise is to place the carton over the frozen block.

Increasing the surface area, as mentioned above, of a mould with strengthening ribs may also have another advantage in that it may have a positive impact on freezing time.

In some embodiments the present invention may be used to introduce controlled air gaps in the frozen meat when stacked.

Other embodiments of the present invention may have some of the sides of the box joined together but be configured so as to allow sides of the box to slide with respect to each other. For example, there may be provided a box comprised of two or more sliding portions that have sufficient stiffness to guide or restrain the meat during the freezing process.

These sliding portions may have tabs bent out of them to allow ready removal of the portions from the meat and again to increase stiffness.

These tabs in some embodiments may be secured together with clips or snug fitting purpose built fasteners.

Handles or other grips may in some embodiments be used instead of tabs.

If the sliding portions are substantially flat, then the component parts of the box may be readily stackable, thus minimising the storage space required when the moulds are not being used. Other portions may be complimentarily shaped for easy stacking as well.

In one embodiment of the present invention, there may be provided corner pieces which hold the sides of the mould together. While these corner pieces may be held in a variety of means, a preferred method is to have wing nuts on a threaded bolt that acts to pin the sides together. The applicant has found that applying a positive pressure on the corners in this manner gives a square edge to the moulded meat which improves its appearance and stowage capability.

To remove the meat the wing nuts need only be loosened, rather than the mould fully disassembled.

Some embodiments of the present invention may incorporate biasing means which can push an inner surface of the mould against the meat but yield as the meat expands from freezing. In some embodiments the biasing means may be in a form of a coiled spring. In other embodiments the biasing means may be the actual surface of the mould which is configured to operate like a leaf spring or perhaps domed or a pyramid in shape.

An alternative to brake pressing a pyramid shape into a mould surface would be to use discrete packing pieces that when stacked form a tapered tier (although in some circumstances a single packing piece may suffice). Dimples may be used for locating each layer and positioning the tier on the base. The layers of the tier beneath the top surface, may be secured by using pins (with clips) or bolts (with nuts). Depending on the gauge of the packing pieces (or piece) used, a degree of chamfering of the top edges of the packing pieces (or piece) may be necessary for easy removal after freezing.

In preferred embodiments of the present invention multiple plates are used to give vertical compression on the meat. The applicant has found that multiple plates (in contrast to other means) provide the vertical compression without sideways expansion with the mould integrity not compromised.

Further, the use of multiple plates means that no springing is required due to the natural flexibility/stiffness offered by the plates.

The applicant believes that the use of multiple plates is the key to allowing controlled expansion of the meat during the freezing process.

In terms of effectiveness, the greater number of plates, the greater amount of volume reduction in the frozen produce. Further, more plates mean smoother and less discrete steps from plate to plate giving a more even pressure on the top of the meat.

However, a greater number of plates leads to greater expense, particularly as the plates are ideally made of a thermally conductive material such as metal. Having material with high thermal conductivity means that the meat can be frozen far quicker.

Thus, in preferred embodiments of the present invention the number of plates used is in the order of 6 to 8, although of course any other greater or smaller number may be used.

Carcasses are generally not very pliant shapes to package. However, in some embodiments of the present invention moulds are provided which have side walls with varying heights.

The carcass moulds may come in a variety of forms and in one embodiment the carcass moulds may be in the form of channels which have slidable lids which hold the channels into place.

Examples of some moulds suitable for use with boneless beef are described below.

The standard weight of boneless beef bulk-packed in cartons is 27.2 kg. If such meat was 85% visual lean, its volume would increase 5% from 0.0262 m³ when fresh to 0.0275 m³ when frozen. In comparison to these before and after freezing volumes, a mould with an internal volume of 0.0293 m³ would respectively be 12% and 6% larger. Thus, 27.2 kg of boneless beef would be expected to fit into moulds with the following internal dimensions.

(a) 0.400 m*0.400 m*0.184 m (0.0294 m³)

(b) 0.600 m*0.400 m*0.123 m (0.0295 m³)

(c) 0.650 m*0.430 m*0.105 m (0.0293 m³)

Nevertheless, by conventional wisdom, with such a small tolerance for expansion such moulds fabricated out of sheet material would be expected to yield to expansive forces during freezing and consequently bulge with little restraint. However, when meat is constrained by moulds, the aforementioned plastic characteristic of meat during freezing, allows the moulds to significantly restrict bulging and results in frozen blocks of a more uniform size being made. Consequently, there is a significant difference between meat frozen in moulds and meat frozen in cardboard cartons, as is common in conventional practice.

Eliminating bulging in these circumstances has considerable impact, as the rectangular space determined by a frozen carton of boneless beef can for example be 33% greater than the external volume of the carton prior to packing.

The flat-surfaced side walls of frozen blocks that are readily and consistently produced by carton-sized moulds mean that blocks can be stably stacked on their sides and ends. Also, the more compact stacking that this allows can raise stowage density.

Stowage density may be raised significantly further in embodiments where bulging is absorbed within the profile of the outer edges such as when blocks can dovetail compactly together because of the respective concave and convex shapes moulded into them.

Rectangular blocks of meat conforming to dimensional options (a), (b) or (c) would be modular with containers and either Europallets (1.2 m*0.8 m) or standard United Kingdom pallets (1.2 m*1.0 m) and therefore achieve optimum space utilisation. Another option, although the end product would not be as compatible with containers and pallets, would be to use moulds that produce rectangular frozen blocks of meat measuring 0.521 m*0.337 m*0.0162 m (0.0284 m³); these blocks would fit inside New Zealand's predominant beef carton.

Dimensional options (b) or (c) are significantly thinner than option (a) or standard cartons; thinner blocks would have the advantage of shorter freezing time.

Other uses of the moulds may include setting or moulding fresh meat as it passes through rigour in the process of chilling.

The applicant has found that use of the mould enables meat to be frozen more quickly than by using the conventional freezing method of freezing meat inside a polythene liner bag, inside a cardboard carton.

What the applicant found is that by freezing the meat inside a polythene liner bag, without a carton, inside a stainless steel mould results in a theoretical reduction in the conventional freezing time (of 37 hours) of a third up to a half.

Freezing the meat inside a stainless steel mould without a polythene liner bag results in a further theoretical reduction of the freezing time by a further third.

One particular advantage of the present invention is the appearance of the moulded meat. Meat frozen in previous systems had excess plastic wrapped loosely around the meat and air gaps which were unsightly.

In comparison, meat frozen in accordance with the present invention is pressed into a regular shape with full contact against the plastic wrapping. The product can be readily seen and the wrapping has a glazed effect on the meat, making it look attractive.

### BRIEF DESCRIPTION OF DRAWINGS

Further aspects of the present invention will become apparent from the ensuing description which is given by way of example only and with reference to the accompanying drawings in which:

FIGS. 1 to 15 illustrate various configurations of moulds in accordance with the present invention

### BEST MODES FOR CARRYING OUT THE INVENTION

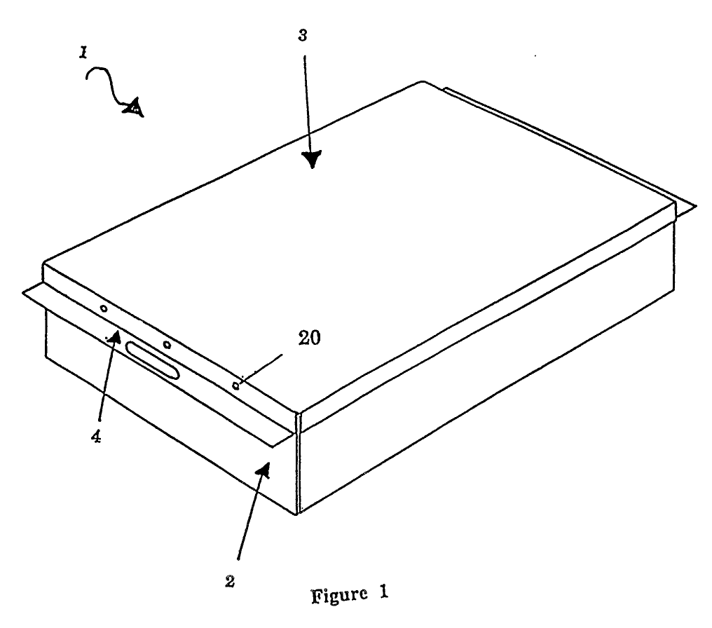

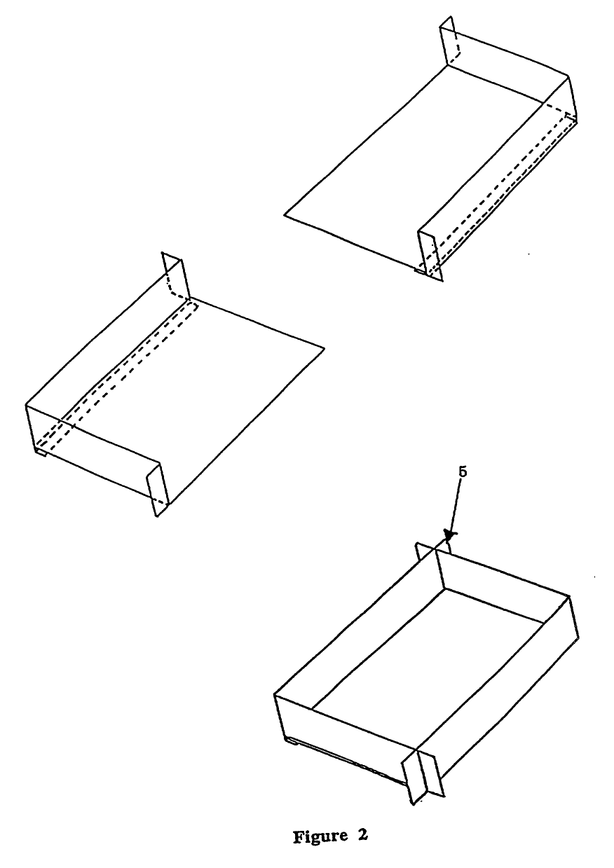

FIG. 1 illustrates a mould in accordance with one embodiment of the present invention. The mould generally indicated by arrow 1 is comprised of a box 2 and a lid 3.

Both the box 2 and the lid 3 are each made from stainless steel sheet metal approximately two millimeters thick.

It can be seen from FIG. 1 that the sides of both the lid 3 and the box 2 are not directly joined together. This enables the meat within the mould 1 to be readily removed therefrom. Intermediate layers (for example plastic film) or non-stick layers for example Teflon™ may also assist with the removal of the meat from the mould.

The stiffness of the sides of the box 2 and in particular the stiffness of the sides of the lid 3 hold the mould 1 together to ensure that the expansion of the meat is accommodated within the mould 1 and blocks of a desirable shape are formed.

In this embodiment the lid 3 has been stiffened and made easier to handle by the inclusion of a flange 4 which may be slotted as shown.

The lid 3 incorporates dimples 20 which help hold the lid 3 on to the box 2.

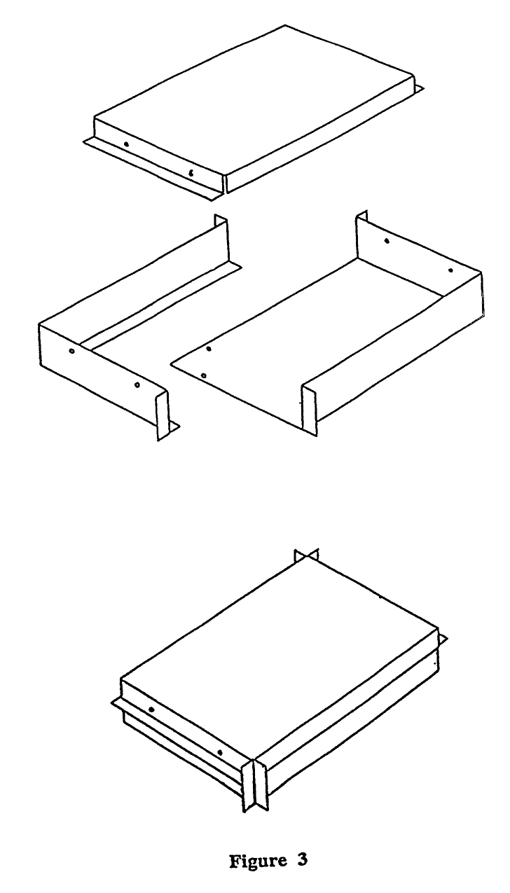

Various design options are illustrated in FIGS. 2 to 7. In these embodiments, the component parts of the base and sides are all detachable with respect to each other. Extending from the sides of these embodiments are tabs 5 for gripping when easing the sides from the frozen meat blocks. The tabs 5 can be secured together with clips or other fastening devices. The clips may be contoured to follow the surfaces of the tabs 5.

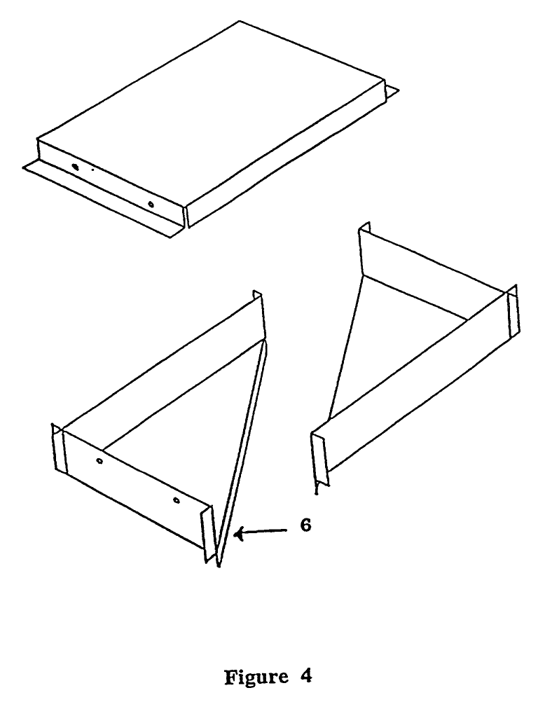

The base illustrated in FIG. 3 is integral with one side and end wall portion of the mould and is supported by flaps extending inward from the other side and end wall portion. The dimples (shown) near the corner of the base locate on dimples (not shown) on the flaps.

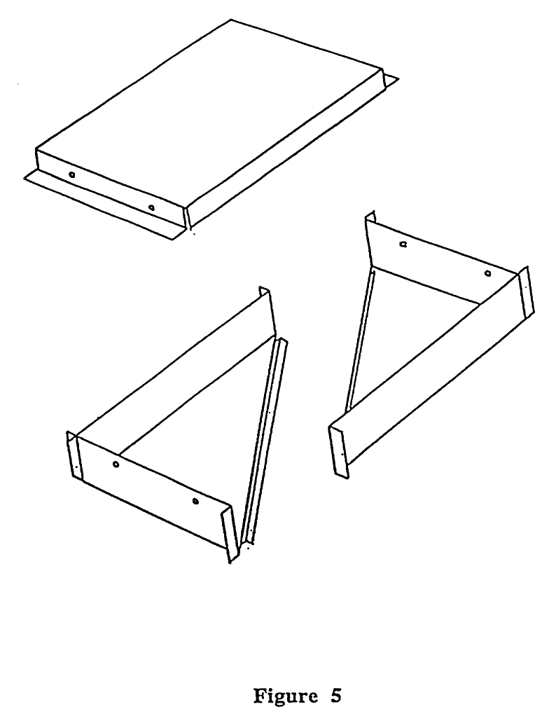

The mould illustrated in FIG. 4 will need to be supported on a base that has a groove to accommodate the diagonal flanges 6 which project downwards from the two halves that form the box. Once loaded, this mould can be inverted.

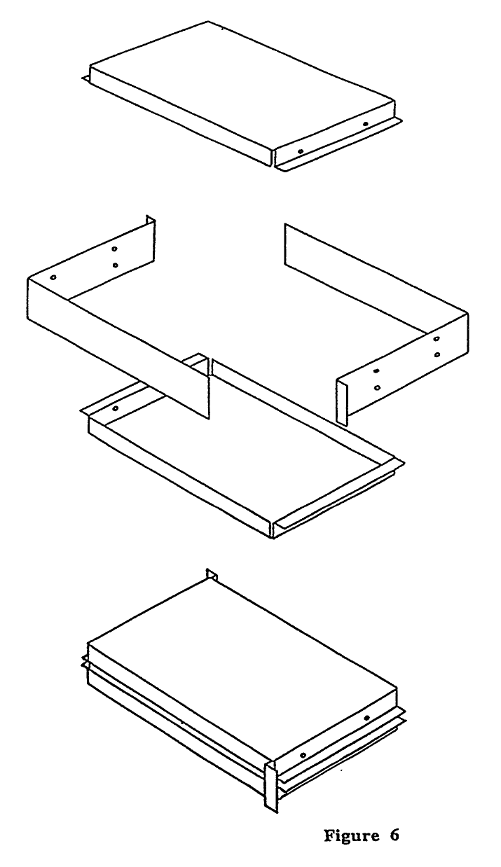

The two pieces which form the box base of the mould in FIG. 5 are designed to be held together by the weight of the meat and thus this mould is not inverted when packed.

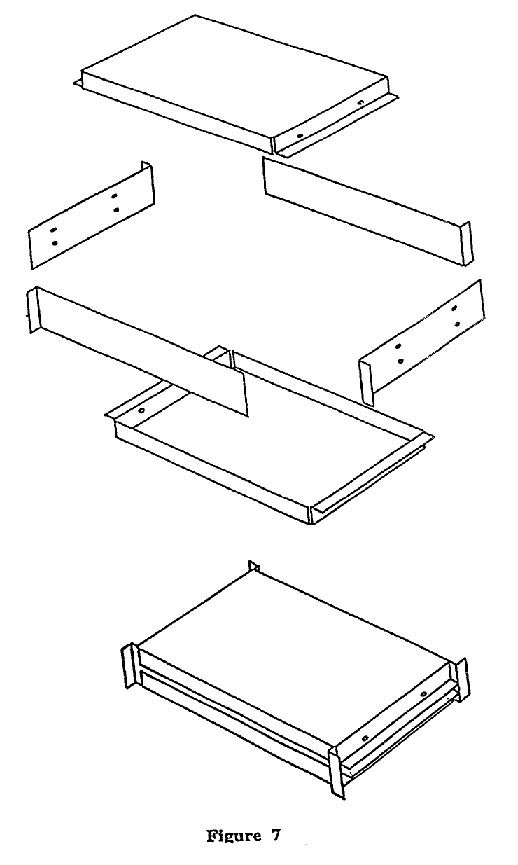

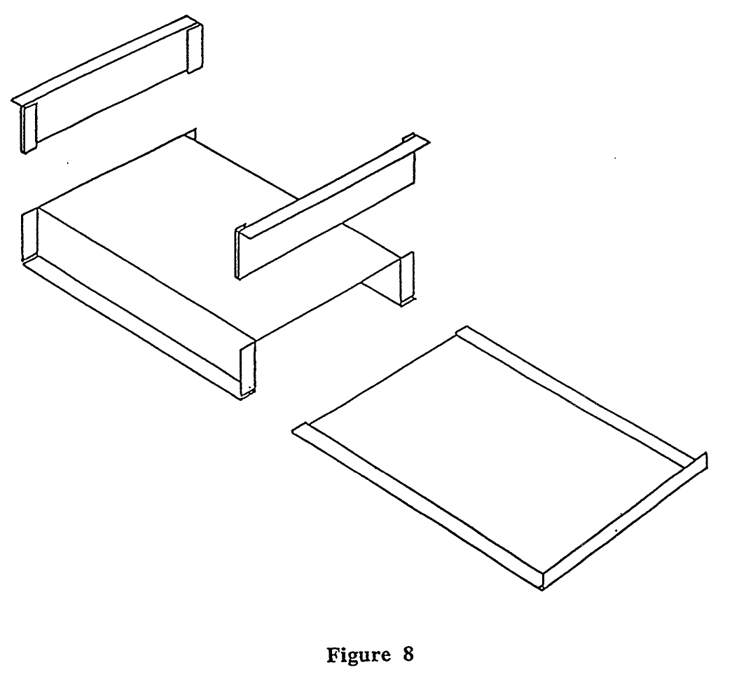

The moulds in FIGS. 6 and 7 have two piece and four piece sides respectively. The base and lid are identical for the mould in FIG. 6 and similarly for the mould in FIG. 7.

When packing the mould in FIG. 8, the U-shaped piece with the two end pieces slid into place is inverted to form a box.

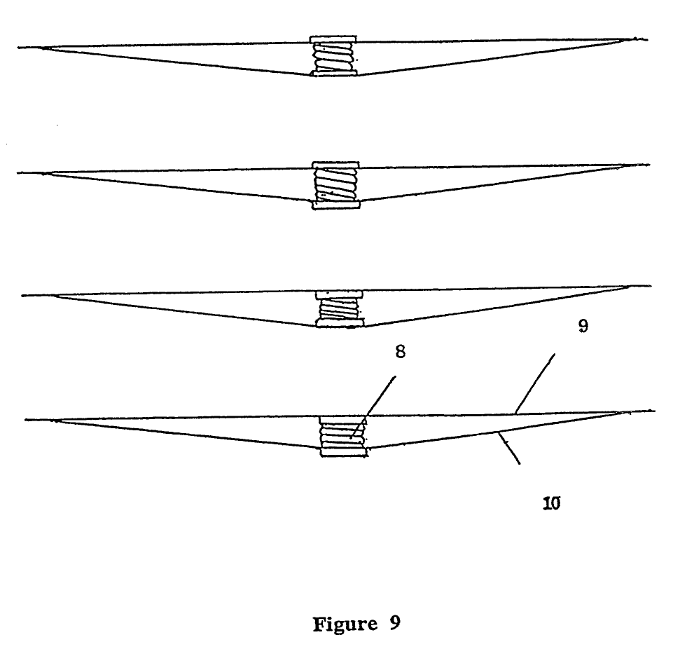

FIG. 9 illustrates the use of biasing means in the form of a coiled spring 8 in combination with two pieces of sheet metal 9 and 10. This configuration, whether for the whole of the top of a mould or for selective parts of the mould ensures that pressure is held on the fresh meat but gives sufficient flexibility to yield to pressure generated by the freezing of the meat. Further, the use of the spring 8 ensures that the sheet 10 returns to its initial position.

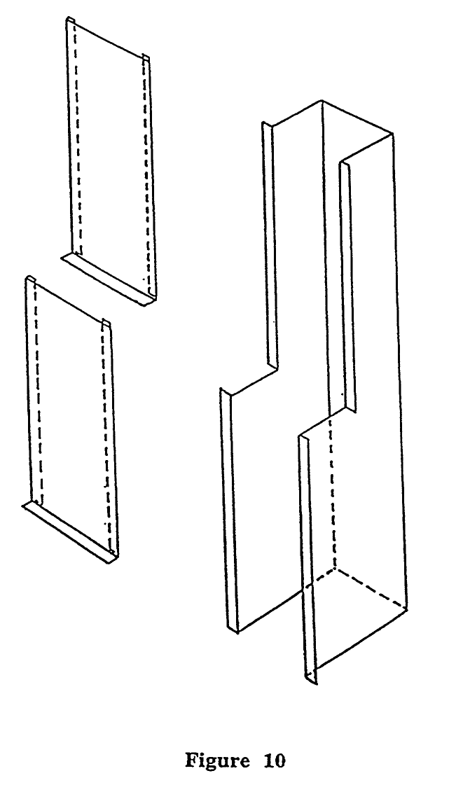

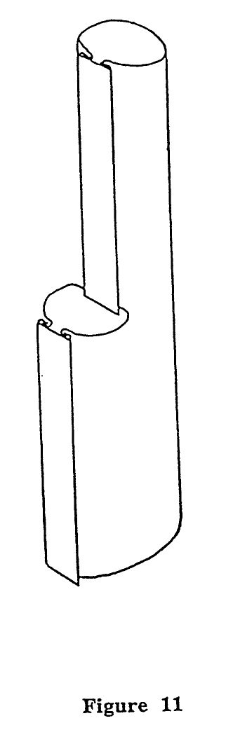

FIGS. 10 and 11 illustrate moulds designed to accommodate carcasses. The carcasses within the moulds may be conveyed vertically (either upright or inverted) or horizontally. If vertical, the carcass might be suspended directly (e.g. using a hook and attaching it to the hind legs) or via the mould (using hangers that slot into holes strategically placed in the mould). If the carcass is bagged before placement in the mould, then the bag itself might be used to support the carcass and mould (e.g. using a hook attached to a handle incorporated within the bag).

Various jointing configurations may be used to further break the mould for compact storage when not in use.

If horizontal, the carcass and mould might be supported by conventional belt conveyors (and even frozen in tunnels designed for cartons) or suspended via hangers or cradles.

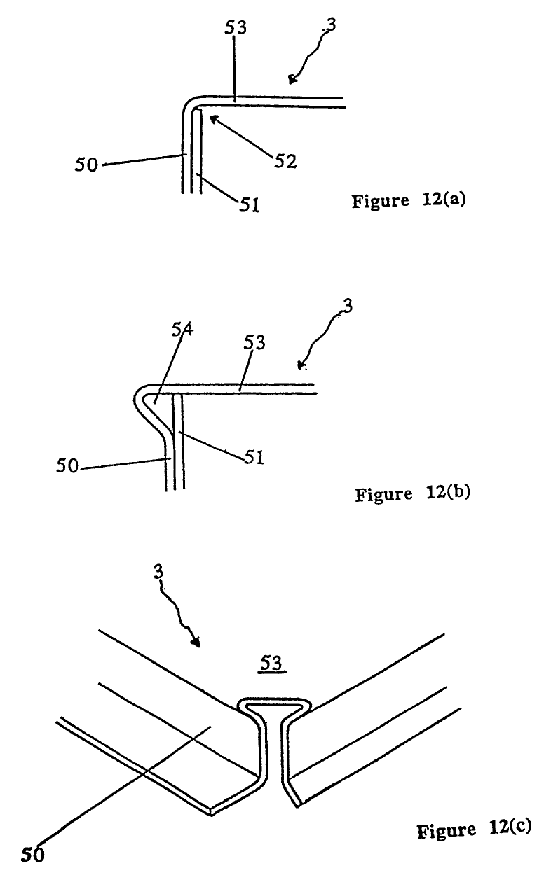

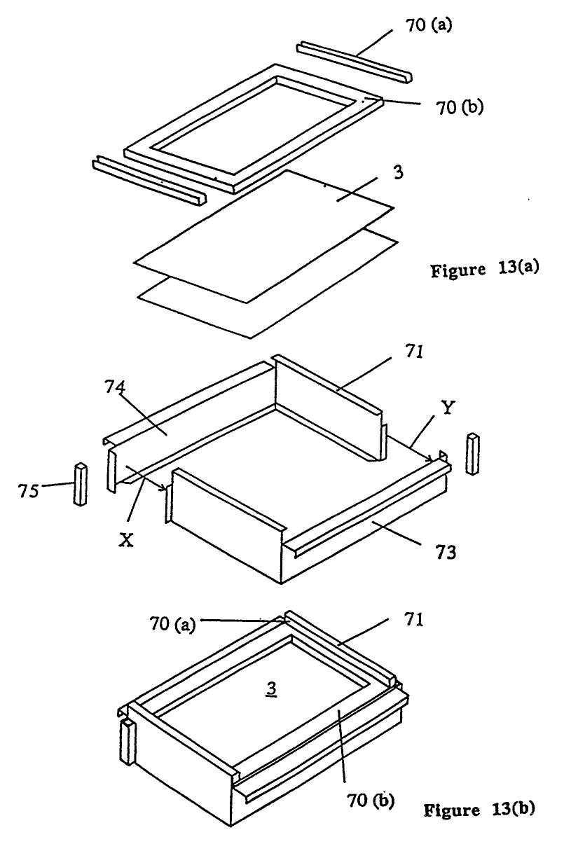

With respect to FIG. 12 there is shown two embodiments (a) and (b) for forming lids 3 for the box 2 (not shown).

In FIG. 12(a) the side portion 50 of the lid 3 is coterminous with the side wall 51 of the box 2.

As shown generally by arrow 52, the top of the side wall 51 is not flush with the roof portion 53 of the lid 3. The resulting gap, indicated by arrow 52 can result in frozen blocks having irregular edges and variable dimensions.

With respect to FIG. 12(b) there is shown a preferred embodiment of the lid 3 which allows for a flush fit between the side wall 51 and the roof portion 53 of the lid 3.

As shown, in order to achieve this flush fit it is necessary to extend the roof portion 53 past the outside edge of the side wall 51 of the box 2. This results in the side portion of the lid 50 not being coterminous with the side wall 51 of the box 2 due to the resultant space 54 separating the side portion 50 from the side wall 51.

The flush fit of the preferred lid embodiment shown in FIG. 12(b) allows for the formation of consistent mould shapes.

With respect to FIG. 12(c) there is shown a perspective view of a preferred embodiment for the lid 3 shown in FIG. 12(b).

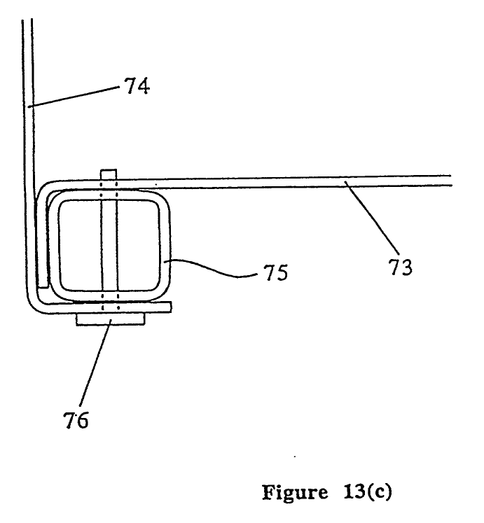

With respect to FIG. 13 there is provided a further embodiment of the present invention which is a variation on the embodiment shown in FIG. 2.

In FIG. 13(a) there is an exploded diagram illustrating the base and lid 3 portions of the mould along with packing pieces 70.

The function of the packing pieces 70 is to provide a compressive force on the lid 3 of the mould and thus on the meat within the mould.

This compression is achieved by placing a packing piece 70(b) on top of the lid 3 (once the meat has been placed in the mould), and then levering the channel shaped packing pieces 70(a) under the flange 71.

FIG. 13(b) is a top plan view of the FIG. 13 embodiment and illustrates in conjunction with FIG. 13(a) how the two side and end wall portions 73 and 74 are joined together so as to form the enclosed walls of the mould.

As can be clearly seen in FIG. 13(b) inserts 75 fit snugly into U sections which are formed when the side and end wall portions 73 and 74 are moved relative to each other as illustrated by the arrows X and Y (shown in FIG. 13(a).

Bolts 76 or any similar securement device may be used to secure the two side and end wall portions 73 and 74 together as shown in FIG. 13(c). Alternatively, or as well bolts 76 the sections 73 and 74 may be clamped together by a bolt or bolts (not shown) at right angles to the bolt 76 shown.

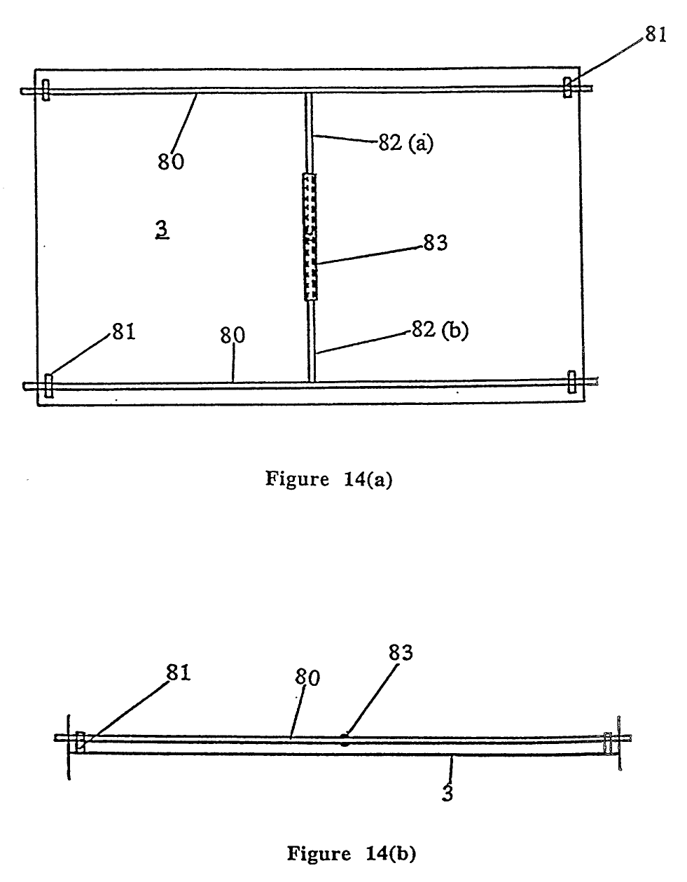

With respect to FIG. 14 there is illustrated an alternative means of providing a compressive force on the meat within the mould.

In FIG. 14 rods 80 may be inserted into apertures in the ends of the mould (not shown) after the lid 3 has been placed on top of the meat.

Attached to, or formed integrally with the rods 80 are cams 81.

To apply a compressive force to the lid 3 the handles 82(a) and 82(b) may be rotated (preferably inwardly) so as to cause the cams 81 to bear down on the lid 3.

When the cams 81 have been moved to their maximum compressive position the handles 82(a) and 82(b) should ideally be in a substantially horizontal position. Although this should not be seen as limiting. When the handles 82(a) or 82(b) are in such a substantially horizontal position a sleeve 83 may be slid over the corresponding handles 82(a) and 82(b) as shown, to help ensure the cams remain in their compressive position, with respect to the lid 3.

FIG. 14(b) is a side view of FIG. 14(a).

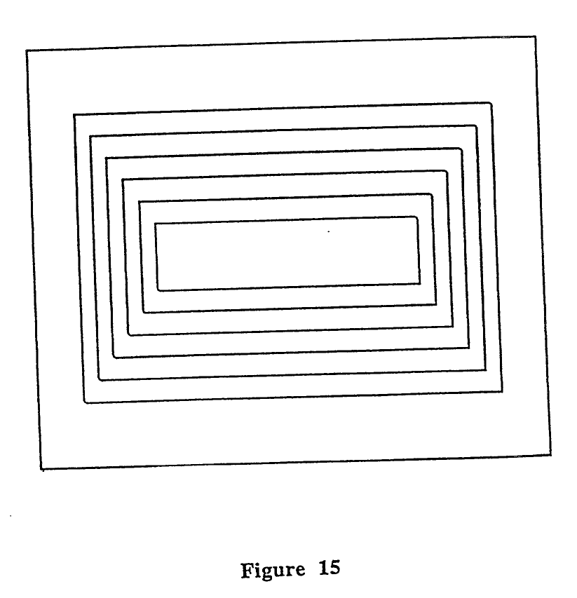

FIG. 15 illustrates a possible lid for use With the present invention which incorporates a number of panels which can act to compress the meat within the mould as it freezes, while retaining some flexibility to accommodate expansion of the meat.

It should be appreciated that different configurations of moulds may be used for different types of carcasses. However, the basic principle of the mould is that accommodation is made for the expansion of meat held within the mould while still serving to set or guide the meat into a desired shape.

It should also be appreciated that many of the design features described above are interchangeable with each other and may be combined in other ways to those given.

Aspects of the present invention have been described by way of example only and it should be appreciated that modifications and additions may be made thereto without departing from the scope thereof as defined in the appended claims.

1. A mould for preforming produce in a frozen state, the mould including top, bottom and side surfaces, a biasing means that yields against the expansive pressure of the produce in a desired manner during freezing, and the mould characterized in that the top, bottom and side elements are configured so that the mould is self-supporting against the forces of expansion by the produce during the freezing process.

2. A mould as claimed in claim 1 wherein the produce is meat.

3. A mould for preforming the produce as claimed in claim 1 wherein the top and bottom surface of the mould are reinforced.

4. A mould as claimed in claim 3 wherein the mould is shaped so that it has a concave base and a convex lid.

5. A mould as claimed in claim 3 wherein part of the mould may be fashioned from magnetic material.

6. A mould as claimed in claim 3 wherein part of the mould is fashioned from material that is able to be gripped by a magnet.

7. A mould as claimed in claim 3 wherein the mould consists of two parts.

8. A mould as claimed in claim 7 wherein the two parts include an open box and a lid.

9. A mould as claimed in claim 8 wherein the edges of the sides of the open box are not joined to each other.

10. A mould as claimed in claim 9 wherein the edges of the sides of the lid are not joined.

11. A mould as claimed in claim 3 wherein the mould includes push-out panels.

12. A mould as claimed in claim 8 wherein the lid and open box possess mating dimples to secure the lid in place against upward pressure.

13. A mould as claimed in claim 8 wherein the lid includes at least one flange.

14. A mould as claimed in claim 3 wherein the mould includes a clamping means to hold the mould components in place.

15. A mould as claimed in claim 8 wherein there is included a mechanical device to aid lid removal.

16. A mould as claimed in claim 8 wherein techniques are employed to provide additional stiffening or flexural rigidity to the material of that the mould is fashioned from.

17. A mould as claimed in claim 2 wherein controlled air gaps are introduced to the frozen meat.

18. A mould as claimed in claim 3 wherein the sides of the box are slidably joined with respect to each other.

19. A mould as claimed in claim 18 wherein the sliding portions of the box include a means for aiding the removal of the sliding portions.

20. A mould as claimed in claim 2 wherein the mould includes a biasing means that can push an inner surface of the mould against the meat but yield as the meat expands from freezing.

21. A mould as claimed in claim 3 wherein the mould includes side walls with varying heights.

22. A mould as claimed in claim 3 wherein the mould is in the form of channels which have slidable lids which hold the channels in place.

23. A method of preforming produce in a frozen state characterized by the step of using a mould as claimed in claim 1.
